(19) United States
(12) Patent Application Publication
(10) Pub. No.: US 2025/0065465 A1
(43) Pub. Date: Feb. 27, 2025

(54) METHOD FOR PROLONGING THE LIFE OF A PRODUCT

(71) Applicant: AKTIEBOLAGET SKF, GOTEBORG (SE)

(72) Inventors: Guillermo Enrique MORALES ESPEJEL, Ijsselstein (NL); Armando FELIX QUIÑONEZ, IJsselstein (NL); Manlio BECCHETTI, Utrecht (NL); Sebastien BLACHERE, Den Haag (NL)

(21) Appl. No.: 18/729,594

(22) PCT Filed: Jan. 25, 2023
(86) PCT No.: PCT/EP2023/051769

§ 371 Date: Jul. 17, 2024

(30) Foreign Application Priority Data
Feb. 8, 2022 (DE) 102022201309.3

(51) Int. Cl. B24B 9/00

(52) U.S. Cl. CPC B24B 9/00

(57) ABSTRACT

A method for prolonging the life of a product that is subjected to Hertzian contact stress when in use and which includes a metal surface having a mean surface profile, the metal surface having at least one crater extending below the mean surface profile and a shoulder at the crater extending above the mean surface profile. The method includes performing a remanufacturing process to remove at least part of the shoulder to produce a finished remanufactured product having all of the crater, or performing a remanufacturing process to remove all of the shoulder and a first portion of the crater and stopping the remanufacturing process before the entire crater is removed to produce a finished remanufactured product having a second portion of the crater extending from the mean surface profile.

### TECHNICAL FIELD

The present invention concerns a method for prolonging the life of a product, such as a machine component, that is subjected to Hertzian contact stress when in use, i.e. Hertzian contact stress or pseudo-Hertzian contact stress when lubrication is included, and which includes a metal surface that comprises at least one indentation.

### BACKGROUND OF THE INVENTION

Indentations in products, such as rolling bearing raceways and rolling elements, are known to be a source of surface damage resulting in shorter service life.

The article by H.-Jurgen Bohmer and Reiner Eberhard entitled “Microstructural Optimisation of Bearing Steels for Operation Under Contaminated Lubrication by Using the Experimental Method of Dented Surfaces”, published in Bearing Steel Technology ASTM STP 1419, on pages 244-262, by the American Society for Testing and Materials International (2002), describes an experimental investigation of the damage mechanisms of anti-friction bearings operating under debris-contaminated lubrication.

The authors of the article disclose that particles in debris-contaminated lubrication which enter the contact zone of a bearing may get pressed into the surface of a bearing during the use of the bearing. The incorporation of a particle into the bearing material results in the formation of a plastically deformed zone around the particle and raised edge (referred to as a “shoulder”) at the bearing surface. This leads to the formation of an indentation having a crater that extends below the surface of the bearing material, i.e. below the mean raceway profile, and a shoulder around the perimeter of the indentation that extends above the surface of the bearing material, i.e. above the mean raceway profile. A shoulder may create metal-to-metal contact between the indented raceway surface and a counter surface, especially in cases where a shoulder rises above a bearing's lubrication film. Such metal-to-metal contact can lead to high stress concentration at, or within the shoulders of indentations, which imparts a high risk of component failure.

Repeated over-rolling of the shoulder of an indentation can namely initiate the formation of cracks due to material fatigue. The cracks generated at the shoulder of an indentation can then propagate below the bearing raceway close to the raceway surface, before they reach the raceway surface again. The material between a crack and the raceway surface may eventually break away, leaving a spall which increases in size with continued over-rolling, and one or more cracks that continue to propagate in the rolling direction. The result is typically a V-shaped spall immediately behind the indentation.

If the indentation is too large, the product has to be scrapped and replaced with a new product. If the size of an indentation is not too large, the product may however be remanufactured by machining the indented metal surface to remove the indentation, i.e. the metal surface may be machined to remove the crater and the shoulder of the indentation to provide a flat and indentation-free surface so that the remanufactured product can continue to be used.

Small indentations are usually removed by polishing and larger indentations are usually removed by grinding.

Polishing is a surface treatment process for creating a smooth surface using a loose abrasive that is driven by another material (such as a polishing compound driven by a work wheel or work plate) or by a person. The width of material removed from bearing raceways is generally between 5 and 20 μm.

Removing a wider layer of material may need more time and possibly a specific process, which may have a significant impact on the cost.

Applying a controlled remanufacturing process before any major damage or component failure occurs can prolong the service life of the component, reducing total life cycle costs, lead times and machine downtime. Additionally, since a remanufacturing process requires less energy than manufacturing a new component, it is better for the environment. Further environmental benefits of remanufacturing include significant savings in terms of resources and waste.

When components with indented surfaces are sent for remanufacturing, the size of the indentations may however require a relatively complex, time consuming and expensive process for their removal, which often means that the component has to be sent to a specialized remanufacturing site, which reduces the carbon dioxide emission-saving that remanufacturing entails. Furthermore, the removal of indentations by grinding may sometimes require the replacement of part of a component, such as the replacement of a complete roller set of a bearing, to compensate for the different internal geometry resulting from the remanufacturing process. This often means that an operator may decide to scrap an indented product and replace it with a new product rather than remanufacturing it depending on the cost of the new component and the size of the indentations on the indented component.

Typically, only large components are considered as candidates for remanufacturing.

### SUMMARY OF THE INVENTION

An object of the invention is to provide an improved method for prolonging the life of a product that is subjected to Hertzian contact stress when in use and which includes a metal surface, i.e. at least one metal surface, having a mean surface profile, whereby the metal surface comprises at least one indentation that has a shoulder extending above its mean surface profile and a crater extending below its mean surface profile.

The method comprises a step of remanufacturing the product by removing at least part of a shoulder or the whole shoulder, but leaving at least part of a crater, such that the remaining part of a crater extends from the mean surface profile, to thereby provide a remanufactured metal surface from which at least part of all of the shoulders or all of the shoulders have been removed. Such a method, which only removes part of an indentation, i.e. the part of an indentation that is predominantly responsible for component failure, rather than the whole indentation, provides a much simpler, faster and more cost-efficient remanufacturing process than remanufacturing processes which remove the whole indentation.

Additionally, the performance of a remanufactured product that has been subjected to the method according to the present invention has been found to be similar to the performance of a product from which all indentations have been removed. The performance of a remanufactured product compared to a new product will however depend on the number and size of the one or more craters remaining in the remanufactured surface and also on external parameters, such as load.

Furthermore, the method according to the present invention leads to a carbon dioxide emission-saving compared with replacing an indented component with a new component.

In the case where there is a single indentation in a metal surface of a product, the expression “removing at least part of a shoulder, but leaving at least part of a crater” as used throughout this document is intended to mean that at least part of a shoulder of that single indentation is removed.

In the case where there is a plurality of indentations in a metal surface of a product, the expression “removing at least part of a shoulder, but leaving at least part of a crater” as used throughout this document is intended to mean that at least part of all of the shoulders or the entire shoulders of all of the indentations in the metal surface are removed, but at least part of the crater of the largest crater in the indented metal sheet, or at least parts of the largest craters of the plurality of indentations in the indented metal sheet remain after the product has been subjected to a method according to the present invention. This means that at least one, some, or all of the craters other than the crater or craters of the largest crater or craters may be removed in their entirety.

An indented metal surface can namely comprise one or more indentations of any shape and size depending on the size, geometry and hardness of the particles that are entrapped in the contact area between the product and another component when the product is in use, although very large particles are not entrapped, and very small particles go through the lubricant film without causing indentations. Soft or malleable (ductile) particles (fibre or metal) produce shallow indentations with shoulders. Brittle, hard particles shatter into many very small particles and produce a cluster of tiny indentations. Friable tough particles produce a large agglomerate of material that dents the metal surface, producing sharp shoulders. Indentations of a large size, or which have large shoulders are the most dangerous.

The term “remanufacturing” as used in this document is intended to mean not only a remanufacturing process step, but applies to all similar process steps, such as process steps aiming to refurbish, recondition, repurpose, restore and/or repair products.

According to an embodiment of the invention, at least one entire shoulder is removed, i.e. 100% of a shoulder, i.e. 0% of a crater is removed, or up to 5%, or up to 10%, or up to 20%, or up to 30%, or up to 40% or up to 50% of a crater is removed. Any crater that remains in the remanufactured metal surface is preferably smaller than the original crater in the indented metal surface. Alternatively, at least 50%, or at least 60%, or at least 70%, or at least 80%, or at least 90% or at least 95% of a should us removed and 0% of the crater is removed.

The expression “mean surface profile” as used herein is intended to mean the surface profile that represents the intended surface contour and desired specifications of the product as manufactured. A mean surface profile will not be geometrically perfect but will not have any surface irregularities that extend beyond manufacturing tolerances. The expressions “shoulder” and “crater” of an indentation refer to irregularities that do extend beyond manufacturing tolerances.

According to an embodiment of the invention, the step of removing at least part of a shoulder, but leaving at least part of a crater may be accomplished using any suitable process, such as at least one of the following: polishing, buffing, electropolishing, cutting, flattening, heat treatment, grinding, honing.

Any suitable surface treatment process that removes at least part of a shoulder of an indentation but does not remove material from the surface of a component thereby changing the shape of a component may be used in the method according to the present invention.

According to an embodiment of the invention the method comprises a step of determining or estimating a dimension or size of a crater, such as the volume, cross-sectional area, depth and/or maximum width of a crater, and conducting the method only if the determined or estimated dimension or size is less than a predetermined critical dimension or size. A dimension or size of a crater may be determined or estimated by visual inspection or measurement using a device and/or an operator's knowledge and/or experience and will depend on the product in question.

According to an embodiment of the invention the product is one of the following: a bearing component, such as an inner or outer bearing ring or rolling element, a bearing raceway or any rolling bearing, such as a needle bearing, a tapered roller bearing, a spherical roller bearing, a toroidal roller bearing, a ball thrust bearing, a roller thrust bearing, a tapered roller thrust bearing, a wheel bearing, a hub bearing unit, a Compact Aligning Roller Bearing (CARB™), a Deep Grove Ball bearing, an angular contact ball bearing, a spherical roller bearing used in a continuous caster line, a backing bearing, a slewing bearing or a ball screw, a transmission component, such as a sprocket, a gear, a bushing, a hub, a coupling, a bolt, a screw, a shaft, such as a spindle shaft, a roller or roller mantle, a seal, a tool, a metal wheel, or any other component for an application in which it is subjected to Hertzian contact stress, or alternating Hertzian contact stress.

According to an embodiment of the invention the step of remanufacturing the product by removing at least part of a shoulder but leaving at least part of a crater comprises removing only a microscopic layer of material having a thickness of up to and including 50 μm from the metal surface, or up to and including 40 μm, or up to and including 30 μm, or up to and including 20 μm, such as a layer of material having a thickness of 5-50 μm or 10-50 μm. Such a microscopic layer of material is preferably removed from the entire metal surface that is being remanufactured. The removal of such a thin surface layer does not change the macrogeometry of the product, such as the diameter or circumference of a product. The removal of material is namely so small as to be visible only with a microscope.

According to an embodiment of the invention the step of remanufacturing the product by removing at least part of a shoulder but leaving at least part of a crater comprises removing a layer of material having a thickness of more than 50 μm, such as a layer of material having a thickness of up to 100 μm or more.

### BRIEF DESCRIPTION OF THE DRAWINGS

The present invention will hereinafter be further explained by means of non-limiting examples with reference to the appended figures where;

FIG. 1 shows an example of a product that can be treated using a method according to an embodiment of the invention,

FIG. 2 shows a two-dimensional profile of an indentation in a metal surface before and after the metal surface has been subjected to a method according to the present invention, and

FIG. 3 is a flow chart showing the steps of a method according to an embodiment of the invention.

It should be noted that the drawings have not necessarily been drawn to scale and that the dimensions of certain features may have been exaggerated for the sake of clarity.

### DETAILED DESCRIPTION OF EMBODIMENTS

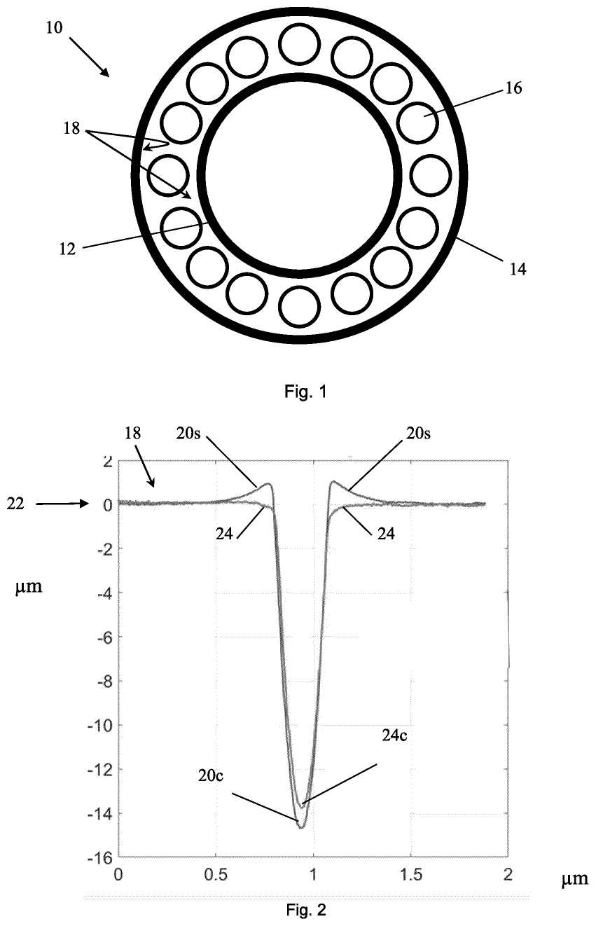

FIG. 1 schematically shows a product 10, namely a rolling element bearing, a metal surface 18 of which may be treated using a method according to an embodiment of the invention.

A metal surface 18 may comprise or consist of any pure metal, such as iron, nickel, titanium, copper, aluminium, tin or zinc, or any metal alloy, such as steel, carbon steel, stainless steel, a nickel-based superalloy, a titanium alloy, brass or bronze.

A product 10 may be any type of bearing, or any other product that is subjected to Hertzian contact stress when in use.

A product 10 may have a diameter up to a few metres in size and have a load-carrying capacity up to many thousands of tonnes. A product 10 may namely be of any size and have any load-carrying capacity. The product 10 may be used in industries such as metals, mining, mineral processing, cement, automotive, renewable or traditional energy, pulp or paper, or marine.

The illustrated rolling element bearing 10 has an inner ring 12 and an outer ring 14 and a set of rolling elements 16. Indentations may appear in the rolling bearing's raceways 18 during the use of the rolling element bearing 10. The over-rolling of solid particles (from contaminated lubricant for example) can namely produce surface indentations of raceways 18 in the rolling-sliding lubricated contacts.

FIG. 2 schematically shows a two-dimensional profile of two indentations 20 and 24 which have been superimposed and aligned along a line that corresponds to 0 on the y-axis, whereby the units shown on the x- and y-axis are microns.

Indentation 20 represents the sole indentation, the largest indentation or one of the largest indentations in an indented metal surface 18 of an product 10 before the indented metal surface is subjected to a method according to the present invention. The Indentation 24 represents the part of the indentation that is left in a remanufactured metal surface 18 after the indented metal surface has been subjected to a method according to the present invention, i.e. after the entire indented metal surface 18 has been remanufactured, by polishing for example.

Since a microscopic layer of material is removed during the method according to the present invention, the remanufactured metal surface will be microscopically lower than the indented metal surface. For example, if an indented raceway of a bearing is subjected to a method according to the present invention, the remanufactured raceway depth may be up to 5 μm lower than the indented raceway depth. This slight difference can be seen since the indentations 20 and 24 are superimposed and aligned along the line that corresponds to 0 on the y axis in FIG. 2.

The mean surface profile 22 of the metal surface 18 may be considered to be the line that corresponds to 0 plus or minus 0.1 units on the y-axis in FIG. 2, whereby ±0.1 unit corresponds to the manufacturing tolerance.

The indentation 20 in the indented metal surface 18 has a shoulder 20s that extends above the mean surface profile 22 and a crater 20c that extends below the mean surface profile 22. A shoulder 20s may for example extend up to 50 μm above the mean surface profile 22. A shoulder 20s may form unevenly around the perimeter of an indentation 20, so that one or more portions of the shoulder 20s may be higher than one or more other portions of the shoulder 20s.

The indentation 24, which is left in the metal surface 18 after the metal surface 18 has been subjected to a method according to the present invention, comprises only a crater 18c and no shoulders since the shoulders 20c of the indentation 20 have been removed and the remanufactured metal surface is flush with the mean surface profile 22, i.e. flush with the remainder of the metal surface 18 within manufacturing tolerances. There is therefore no longer any material that extends above the mean surface profile 22 at the location 24 where the shoulder 24s was located after the metal surface has been subjected to a method according to the present invention. At least part 24c of the crater 20c of the indentation 20 is however still left in the metal surface 18. The size of the remaining crater 24c will not however adversely affect the performance of the remanufactured product 10. The remanufactured metal surface is namely a flat surface which has smaller differences between its highest and lowest points compared to an indented metal surface before it is subjected to the method according to the present invention, meaning there are fewer microscopic stress concentrations where a crack can be initiated, thereby improving fatigue life of the product 10.

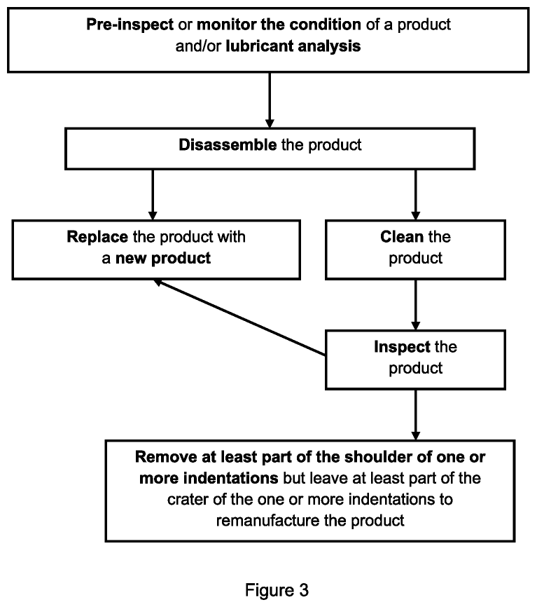

FIG. 3 is a flow chart showing the steps of a method according to the present invention. The method comprises the steps of optionally pre-inspecting and/or monitoring the condition of product 10 to see whether it comprises any indentations 20 comprising a shoulder 20c and a crater 20c in which the crater 20c has a dimension or size that is greater than a predetermined critical dimension. A crater 20c may for example have a maximum width at the surface of the metal surface 18 that is greater than a predetermined maximum width and/or a maximum cross-sectional area the metal surface 18 that is greater than a predetermined maximum cross-sectional area).

At least one indentation 20 may be formed during the use, manufacture, assembly, mounting and/or transportation of the product 10. The method according to the present invention may optionally comprise the step of analyzing a machine's lubricant or lubrication system to determine whether a product 10 may comprise at least one indentation 20.

If a product 10 comprises at least one indentation 20 having a dimension or size greater than a predetermined critical dimension or size, it may optionally be cleaned and inspected more carefully after disassembling the product 10 from a machine in which it is mounted if it is mounted in a machine. The severity of the indentation(s) in a metal surface 18 of the product 10 may be determined by visual inspection and/or measurement using any suitable means to determine whether the product is a candidate for remanufacturing using a method according to the present invention.

If the indented product 10 comprises at least one indentation having a crater that is greater than a predetermined critical dimension or size, the indented product 10 may be scrapped and replaced with a new product 10. For example, if a two-dimensional cross-sectional area of a crater 20c is greater than the contact area between the product 10 and another component when the product 10 is in use, the indented product 10 may be scrapped and replaced with a new product. The predetermined critical dimension or size will depend on the size of the product 10 and the load to which it is subjected during use, and is known to the skilled person. Normally, it is the size or volume of a crater 20c of an indentation that is important as regards the decision of whether to remanufacture the product 10 or not, and not its depth.

If the indented product 10 comprises only one or more indentations 20 having a crater 20c that is less than a predetermined critical dimension or size, the service life of the indented product 10 may be prolonged by remanufacturing the indented metal surface of the indented product using a method according to the present invention 10. An indented metal surface 18 of the product 10 may namely be surface-treated, by polishing for example, so as to remove at least part of the shoulders 20s of the one or more indentations 20, but so as to at least part of a crater 20c of the sole indentation 20 in the indented metal surface 18, or of the largest indentation 20 in the indented metal surface 18, such that the remaining part 24c of a crater 24c extends from the mean surface profile 22 of the remanufactured metal surface 18 which comprises an indentation 24 having only a crater 24c that has a dimension or size that is less than the predetermined critical dimension or size, but no shoulder.

The crater 24c of an indentation 24 remaining in the remanufactured metal surface 18 may be at least 50%, or at least 60%, or at least 70%, or at least 80%, or at least 90%, or 100% of the size of the crater 20c of the indentation 20 in the indented product 10 (measured from the mean surface profile 22 of the metal surface 18, and not from the tip of a shoulder 20s of the indentation 20) before the indented product 10 is subjected to a method according to the present invention.

The thickness of the surface layer of the indented metal surface 18 of the product 10 which is removed during the method according to the present invention depends on the size of the indentation or the largest indentation(s) in the indented metal surface 18. One or more indentations that are smaller than the largest indentation(s) may be completely removed, but at least part 24c of a crater 20c will remain in the remanufactured metal surface 18. The size of the remaining part 24c of any crater in the remanufactured metal surface 18 can optionally be checked to ensure that the remaining part 24c of any crater will not adversely affect the performance of the remanufactured product 10.

An indented product 10 may be polished so as to remove only a microscopic layer of material having a thickness of up to 50 μm from its metal surface 18. The remanufactured product 10 may then be assembled, or re-assembled, in a machine.

It should be noted that a method according to the present invention may be used for prolonging the life of a particular product 10 more than once, i.e. the method may be used to prolong the life of a product 10 a plurality of times. The method may for example be used to remove at least the shoulders of indentations until or after such a removal of at least the shoulders of indentations requires the replacement of some part of the product, such as the replacement of a complete roller set if a roller bearing, to compensate for the different internal geometry resulting from the remanufacturing process.

The condition of a new or remanufactured product 10 may be monitored so that the full benefits of the method according to the present invention can be achieved by conducting the method at an optimum time before a new or remanufactured product 10 is damaged to a degree that does not allow subsequent remanufacturing.

Further modifications of the invention within the scope of the claims would be apparent to a skilled person.

1. A method for prolonging the life of a product that is subjected to Hertzian contact stress when in use and which includes a metal surface having a mean surface profile, the metal surface having at least one crater extending below the mean surface profile and a shoulder at the crater extending above the mean surface profile,
the method comprising:
performing a remanufacturing process to remove at least part of the shoulder to produce a finished remanufactured product having all of the crater, or
performing a remanufacturing process to remove all of the shoulder and a first portion of the crater and stopping the remanufacturing process before the entire crater is removed to produce a finished remanufactured product having a second portion of the crater extending from the mean surface profile.

2. The method according to claim 1, wherein the remanufacturing process comprises at least one process selected from the group consisting of: polishing, buffing, electropolishing, cutting, flattening, heat treatment, grinding and honing.

3. The method according to claim 2, including, determining or estimating a dimension or size of the crater.

4. The method according to claim 1, wherein the product is selected from the group consisting of: an inner or outer bearing ring, a bearing raceway, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a Compact Aligning Roller Bearing (CARB™), a Deep Grove Ball bearing, an angular contact ball bearing, a spherical roller bearing configured for use in a continuous caster line, a backing bearing, a slewing bearing, a ball screw, a sprocket, a gear, a bushing, a hub, a coupling, a bolt, a screw, a shaft, a roller or roller mantle, a seal, a tool or a metal wheel.

5. The method according to claim 1, including stopping the remanufacturing process before removing 50 μm from metal surface.

6. The method according to claim 1, including removing a layer of material having a thickness of more than 50 μm from the metal surface.

7. The method according to claim 1, including stopping the remanufacturing process before removing 50% of the crater.

8. The method according to claim 1,
wherein the method comprises performing the remanufacturing process to remove all of the shoulder and the first portion of the crater.

9. The method according to claim 1,
wherein the method comprises performing the remanufacturing process to remove at least part of the shoulder to produce the finished remanufactured product having all of the crater.
